(19) United States
(12) Patent Application Publication
(10) Pub. No.: US 2008/0100713 A1
(43) Pub. Date: May 1, 2008

(54) Camera module of an electronic device

(75) Inventor: Chun-Hu Liu, Tao Yuan Shien (TW)

Correspondence Address: RABIN & Berdo, PC, 1101 14TH STREET, NW, SUITE 500, WASHINGTON, DC, 20005, US

(73) Assignee: Quanta Computer Inc., Tao Yuan Shien (TW)

(21) Appl. No.: 11/703,072

(22) Filed: Feb. 7, 2007

(30) Foreign Application Priority Data
Oct. 26, 2006 (TW) 95218960

(51) Int. Cl. H04N 9/04

(52) U.S. Cl. 348/207.99; 348/E09.002

(57) ABSTRACT

A camera module installed on an electronic device is described. A main body is rotatably connected with the electronic device. An image sensing unit is disposed on the main body for obtaining images. A magnetic sensor is disposed on the main body. A magnet is disposed on the electronic device. When the main body rotates, a magnetic field density measured by the magnetic sensor varies as a distance between the magnetic sensor and the magnet varies. A control unit is to judge a position of the image sensing unit according to the magnetic field density measured by the magnetic sensor.

### RELATED APPLICATIONS

The present application is based on, and claims priority from, Taiwan Application Serial Number 95218960, filed on Oct. 26, 2006, the disclosure of which is hereby incorporated by reference herein in its entirety.

### BACKGROUND

1. Field of Invention

The present invention relates to a camera module. More particularly, the present invention relates to a camera module installed on an electronic device.

2. Description of Related Art

In recent years, CMOS (Complementary metal-oxide-semiconductor) image sensors are popularly implemented in various types of electronic devices, such as a cellular phone, a notebook computer or a PDA, as a key component of a camera module.

In several cases, a camera module can be rotated relative to the body where the camera module installed on for user's convenience. When the camera module rotates by 180 degrees, an image obtained by the camera module is upside down or abnormal (right side and left side are reversed), an image adjustment is necessary to get a normal image displayed on a screen.

### SUMMARY

A camera module installed on an electronic device includes the following components. A main body is rotatably connected with the electronic device. An image sensing unit is disposed on the main body for obtaining images. A magnetic sensor is disposed on the main body. A magnet is disposed on the electronic device. When the main body rotates, a magnetic field density measured by the magnetic sensor varies as a distance between the magnetic sensor and the magnet varies. A control unit judges a position of the image sensing unit according to the magnetic field density measured by the magnetic sensor.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a camera module of an electronic device according to one embodiment of this invention;

FIG. 2 illustrates a view of the camera module in FIG. 1 rotated by 180 degrees;

FIG. 3 illustrates a camera module of an electronic device according to another embodiment of this invention;

FIG. 4 illustrates a view of the camera module in FIG. 3 rotated by 180 degrees; and

FIG. 5 illustrates a block diagram according to this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

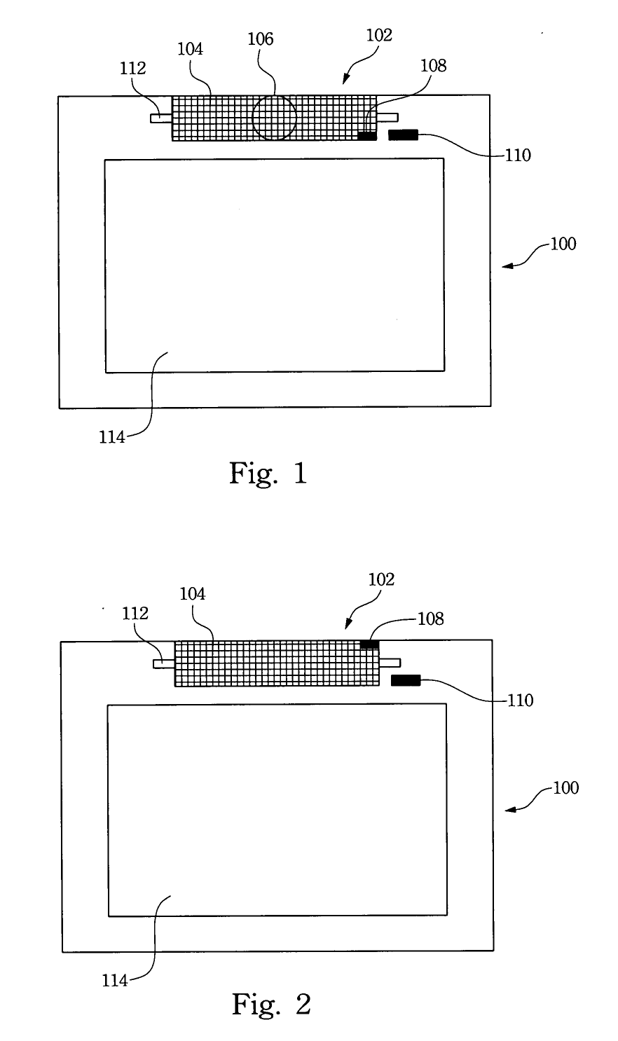

FIG. 1 illustrates a camera module of an electronic device according to one embodiment of this invention. FIG. 2 illustrates a view of the camera module in FIG. 1 rotated by 180 degrees.

Please refer to FIG. 1 and FIG. 2. A camera module 102 is installed on an electronic device 100, such as a cellular phone, a notebook computer or a PDA. The camera module 102 has a main body 104 rotatably connected with the electronic device 100 by a hinge 112. Thus, the main body 104 rotates and an image sensing unit 106 thereof can obtain images from different view points. When the image sensing unit 106 rotates from a position illustrated in FIG. 1 to a position illustrated in FIG. 2 (by about 180 degrees), an image, obtained by the image sensing unit 106 and output by an display screen 114, is turned upside down. The image sensing unit 106 includes a set of lenses and a CMOS (Complementary metal-oxide-semiconductor) image sensor or CCD (charge-coupled device) image sensor. The set of lenses projects the obtained image on the CMOS or CCD image sensor. The image sensor converts an optical signal (the obtained image) into an electrical signal to be sent to a processor, i.e. a Digital Signal Processor, for further processing.

In this embodiment, a distance between a magnetic sensor and a magnet is used to judge a position where the image sensing unit is rotated to such that above-mention issue, i.e. an image, obtained by the image sensing unit 106 and output by an display screen 114, is turned upside down. The magnetic sensor 108 is positioned on the main body 104 of the camera module 102, and the magnet 110 is positioned on the electronic device 100. When the main body 104 rotates, a distance between the magnetic sensor 108 (such as a Hall effect sensor) and the magnet 110 varies, a magnetic field density of the magnet 110 measured by the image sensing unit 108 varies. For example, the distance between the magnetic sensor 108 and the magnet 110 as illustrated in FIG. 1 is shorter (compared with FIG. 2), the magnetic field density of the magnet 110 measured by the magnetic sensor 108 is stronger. The distance between the magnetic sensor 108 and the magnet 110 as illustrated in FIG. 2 is longer (compared with FIG. 1), the magnetic field density of the magnet 110 measured by the magnetic sensor 108 is weaker.

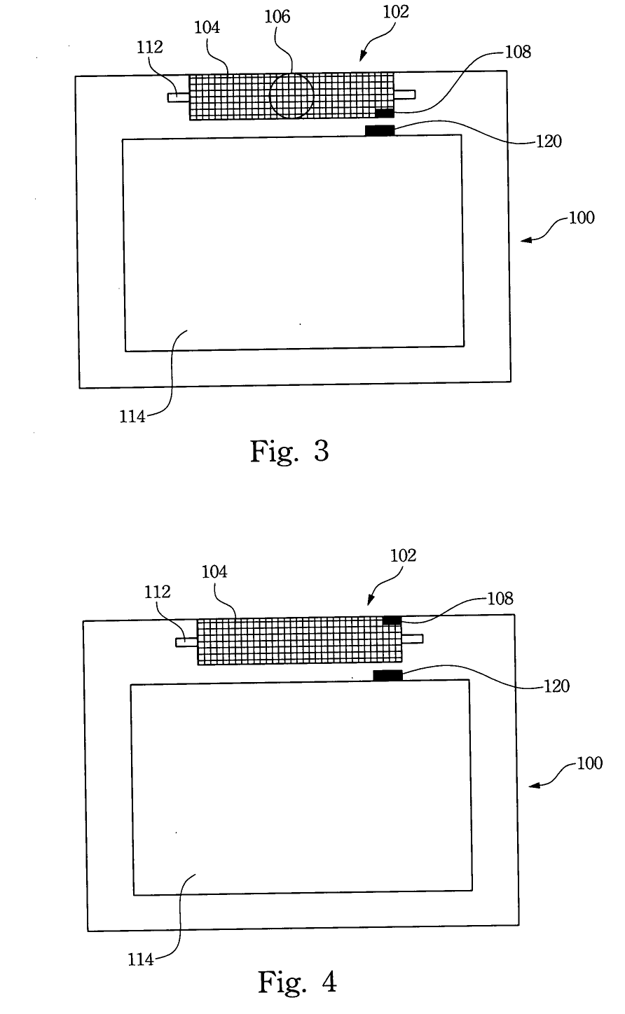

Arrangements of the magnetic sensor and the magnet can be varied. FIG. 3 illustrates a camera module of an electronic device according to another embodiment of this invention. FIG. 4 illustrates a view of the camera module in FIG. 3 rotated by 180 degrees. Compared with the embodiment illustrated in FIG. 1 and FIG. 2, the magnet 120 is located on a different position of the electronic device 100. The distance between the magnetic sensor 108 and the magnet 120 as illustrated in FIG. 3 is shorter (compared with FIG. 4), the magnetic field density of the magnet 120 measured by the magnetic sensor 108 is thus stronger. The distance between the magnetic sensor 108 and the magnet 120 as illustrated in FIG. 4 is longer (compared with FIG. 3), the magnetic field density of the magnet 120 measured by the magnetic sensor 108 is thus weaker.

Besides embodiments discussed above, there might be other arrangements of the magnetic sensor and the magnet. As long as a magnetic field density measured by the magnetic sensor varies as a distance between the magnetic sensor and the magnet varies, the arrangement of the magnetic sensor and the magnet is acceptable. Besides, both of the two components 108 and 110 (including 120) also could be switched, for example, the component 110 (and component 120) is a magnetic sensor while the component 108 is a magnet.

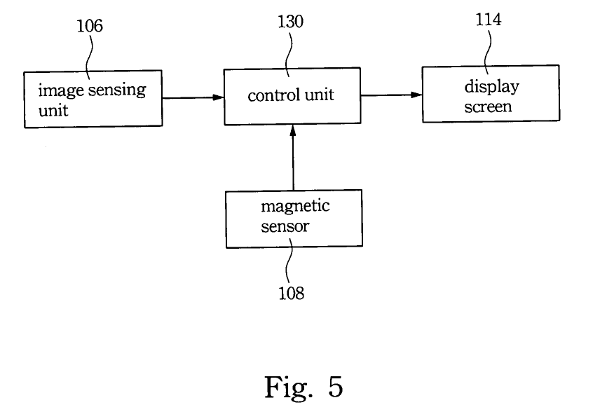

FIG. 5 illustrates a block diagram according to this invention. In order to judge a position of the image sensing unit 106 according to the magnetic field density measured by the magnetic sensor 108, a control unit 130 is necessary. One or more predetermined values are stored in the control unit 130, which receives the magnetic field density measured by the magnetic sensor 108 and compares the magnetic field density with the predetermined values. After the comparison, the control unit 130 determines whether or not an image, obtained by the image sensing unit 106 and output by an display screen 114, should be turned upside down or otherwise adjusted (in order to get a normal image on the display screen 114). The control unit 130 can be implemented by a microprocessor or a DSP. That is, the microprocessor or DSP receives the signal transmitted from the image sensing unit 106, and judges the position where the image sensing unit is rotated to according the magnetic field density measured by the magnetic sensor 108 so as to determine whether or not an image, obtained by the image sensing unit 106 and output by an display screen 114, should be turned upside down or otherwise adjusted (in order to get a normal image on the display screen 114).

According to embodiments of this invention, an arrangement of the magnetic sensor and the magnet used to judge a position, where the image sensing unit is rotated to, is a more reliable mechanism than conventional mechanical hinge.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A camera module installed on an electronic device, the camera module comprising:
a main body, rotatably connected with the electronic device;
an image sensing unit, disposed on the main body for obtaining images;
a magnetic sensor, disposed on the main body;
a magnet, disposed on the electronic device, when the main body rotates, a magnetic field density measured by the magnetic sensor varies as a distance between the magnetic sensor and the magnet varies; and
a control unit for judging a position of the image sensing unit according to the magnetic field density measured by the magnetic sensor.

2. The camera module of claim 1, wherein the magnetic sensor is a Hall effect sensor.

3. The camera module of claim 1, wherein the image sensing unit comprises a CMOS image sensor and a set of lenses.

4. The camera module of claim 1, wherein the image sensing unit comprises a CCD image sensor and a set of lenses.

5. An electronic device, comprising:
a display screen; and
a camera module, obtaining an image to be output by the display screen, the camera module comprising:
a main body, rotatably connected with the electronic device;
an image sensing unit, disposed on the main body for obtaining images;
a magnetic sensor, disposed on the main body;
a magnet, disposed on the electronic device, when the main body rotates, a magnetic field density measured by the image sensing unit varies as a distance between the magnetic sensor and the magnet varies; and
a control unit for judging a position of the image sensing unit according to the magnetic field density measured by the magnetic sensor and whether or not the image obtained by the camera module and output by the display screen should be adjusted so as to get a normal image on the display screen.

6. The electronic device of claim 5, wherein the magnetic sensor is a Hall effect sensor.

7. The electronic device of claim 5, wherein the image sensing unit comprises a CMOS image sensor and a set of lenses.

8. The electronic device of claim 5, wherein the image sensing unit comprises a CCD image sensor and a set of lenses.

9. The electronic device of claim 5, wherein the electronic device is a notebook.
